(19) United States
(12) Patent Application Publication
(10) Pub. No.: US 2011/0001456 A1
(43) Pub. Date: Jan. 6, 2011

(54) Apparatus and method for managing a plurality of secondary batteries

(76) Inventor: Shun-Hsing Wang, Banciao City (TW)

Correspondence Address: Shu-Hsing Wang, 2f No. 10 Alley 21 Lane 32 Sec. 1, Wen-Hua Rd. 22002, Banciao, Taipei Country, TW

(21) Appl. No.: 12/789,465

(22) Filed: May 28, 2010

(30) Foreign Application Priority Data
Jul. 6, 2009 (TW) 98122706

(51) Int. Cl. H02J 7/00

(52) U.S. Cl. 320/117

(57) ABSTRACT

The present invention comprising the series-parallel switches and method of connecting a plurality of batteries in series, parallel, or both dynamically by controlling the series-parallel switches to form an electrically connected battery pack. A monitor processing unit monitors unbalance among batteries and selectively changes the states of series-parallel switches to balance the voltage different among batteries.

### CROSS REFERENCE TO RELATED APPLICATIONS

This application claims priority of Taiwan Patent Application Serial No. 98122706 entitled “A Method of Managing Multi Secondary Batteries,” filed on Jul. 6, 2009.

### FIELD OF THE INVENTION

The present invention relates to apparatus and method for managing a plurality of batteries, and more particularly to apparatus and method for changing the connections of batteries to extend the life cycle and increase efficiency of a battery pack.

### BACKGROUND OF THE INVENTION

Currently, different type of battery pack such as secondary rechargeable battery, solar cell battery, or fuel cell battery are used in many electronic system. A battery pack is composed of a plurality of batteries with the same type of characteristics are connected or stacked up in series to reach the desired high voltage and connected in parallel to increase the overall charge capacity. Moreover, a battery itself is a single cell or is composed of a plurality of cells are connected in series or parallel, or both to increase the overall voltage and charge capacity. The connections, serial or parallel, among the secondary batteries and cells welded permanently can't be changed easily. Protection IC, which is called analog front end, with analog to digital converter, MOS switches, fuses and protection circuit are used to monitor and protect battery from dangerous situations such as high/low temperature, over/short current, over/under voltage, etc. The information of each battery such as voltage, temperature even current and state of charge (SOC) can be provided to external devices via bus protocol. Usually, in the secondary battery powered system, a dual-direction power converter is used to transform and regulate the input/output voltage and current to the required level between battery pack and load-power supply device.

For example, four Lithium-Cobalt (Li—Co) batteries (capacity 2000 mAh) can be connected in series to provide 10 volt of load. The working environmental limitation of Li—Co cell includes: maximum charging voltage is equal to 4.2V; maximum charging current is equal to 1 C (C times capacity=current, e.g., 1 C*2000 mAh=2000 mA); minimum discharging voltage is equal to 3.0V, maximum discharging current is equal to 2.5 C; and working temperature is between 0 to 55 degrees Celsius. Integrated monitor processor can measure the voltages, temperatures, and current of cells; moreover, it can calculate the state of charge of battery pack and also can control the MOSFET to turn off charging/discharging route to protect battery from dangerous situations during charging and discharging of the secondary battery. If a load requests 10 volt power source, for example, the power converter will transform the pack output voltage to 10 volt. The typical charging process is as following. Initially, the charging circuit will charge the Li—Co battery at 1 C constant current, and when the overall voltage of the battery pack is over 16V, it shifts to charge the Li—Co batteries at constant 16.8V until cell voltage is at least 4.2V, the overall voltage is at least 16.8V, or the current is smaller than the cutoff current.

Although secondary batteries connected in series operate at the same current, each secondary battery has its own voltage which may not be the same as the others. The time reaching the cutoff voltage for charging or discharging is highly dependent on the status of individual secondary battery. As a result, the operation time as well as useful charge capacity of each battery is dominated by the secondary battery of the worst status. This is called the unbalance among batteries. Each of secondary battery has its own battery healthy status becomes inconsistent after charging and discharging repeatedly. Currently, there are two solutions to cope with the unbalance situation among secondary batteries.

Active Balance:

A flyback or charge-pump capacitor together with a control circuit is used to shift the charge of a high voltage battery to a low voltage battery to balance the voltage between the two secondary batteries. However, the efficiency of this approach is low and the cost of circuit design is high.

Passive Balance:

This approach is to connect each secondary battery in parallel with a small resistance. In charging process, a MOS switch is implemented to control an electrical current to flow through the secondary battery of high voltage to the parallel resistance such that the electrical charge of this secondary battery is consumed to achieve suppressing the voltage and to prevent the voltage from overshooting. This process consumes energy and therefore generates heat while balancing the high voltage batteries. In order to prevent the entire battery pack from overheat, the resistance needs to keep small, it leads to prolong the entire balanced time.

Another drawback of using a battery pack is that when one of the batteries is worn or disabled, the entire battery pack needs to be abandoned or replaced, which wastes lots of material and increases cost.

### SUMMARY OF THE INVENTION

In accordance with one preferred embodiment of the present invention, it comprises of a series-parallel switch been included between adjacent batteries which can change the connection of adjacent batteries into series or parallel. Therefore dynamical connect a plurality of batteries in series, parallel, or both according to the operative requirements of battery pack. Whenever the unbalance among batteries occurs, it changes the switches to parallel-wound to balance the voltage among series-wound batteries. It also can bypass disabled batteries in the battery pack by changing the connective configuration of battery pack. Therefore, can help the problems of using a battery pack.

Further areas of applicability of the present teachings will become apparent from the description provided herein. It should be understood that the description and specific examples are intended for purpose of illustration only and are not intended to limit the scope of the present teachings.

### BRIEF DESCRIPTION OF THE DRAWINGS

FIG. 1 is a schematic view showing the system for implementing a preferred embodiment of the present invention.

FIG. 2 is a schematic view showing the connection of four batteries and a series-parallel switch between two batteries can switch to serial or parallel connective state.

FIG. 3 is a schematic view showing the variety of connections adopted in the preferred embodiment of the present invention;

### DETAILED DESCRIPTION OF THE INVENTION

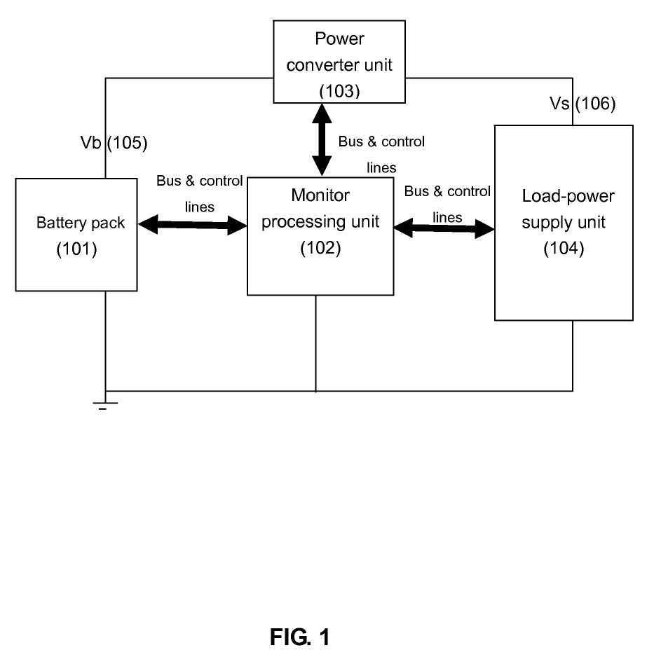

With reference to FIG. 1, it is shown that the system used in one preferred embodiment of the present invention may include a battery pack 101 composed of a plurality of secondary batteries with pack voltage 105, a monitor processing unit 102, a power conversion unit 103, and a load-power supply unit 104 with operation voltage 106 for providing a discharge load and a charge source.

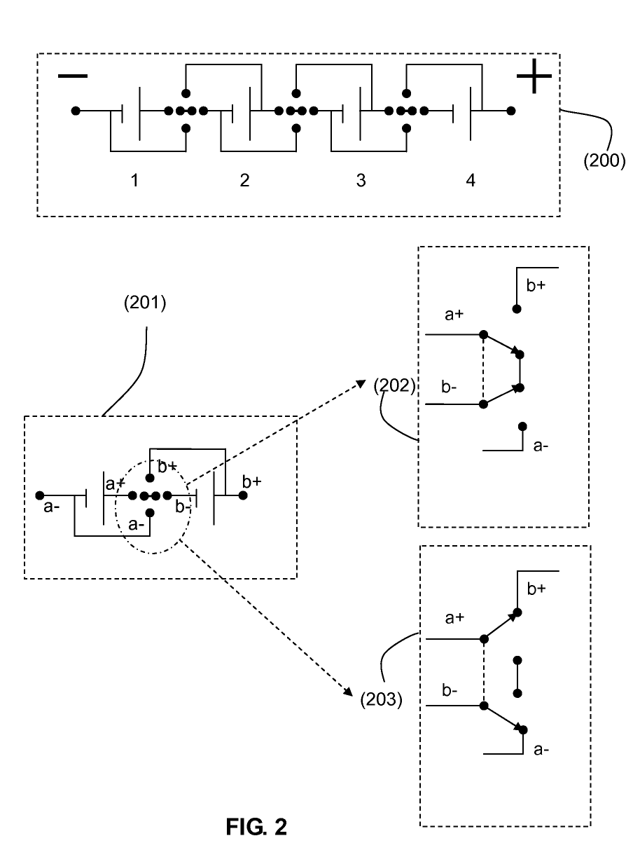

Inside the battery pack 101, a plurality of ordinal secondary batteries with protection and/or monitor circuit inside each battery are connected in parallel and/or in series with another electrically e.g. 200 of FIG. 2. The monitor processing unit 102 can monitor the voltage, temperature, current, or protection information of each battery via bus protocol or analog to digital converter, can control the states of series-parallel switches among batteries and the on/off state of charging/discharging route of the battery pack 101 through the control lines directly or through bus commands indirectly. The power conversion unit 103 is responsible for power regulation and conversion between the power pack 101 and the load-power supply unit 104.

With reference to FIG. 2, taking the reference numeral 200 for example, it is shown that four batteries are connected electrically by the series-parallel switches to form a battery pack. A series-parallel switch 201 is implemented between adjacent batteries so that an external device is able to change the state of the series-parallel switch 201. The series-parallel switch 201 is a double pole, double throw (DPDT) type mechanical switch, electronic MOS, or relay switch, when activated, the connection of two batteries is able to change from parallel to serial 202 or from serial to parallel 203.

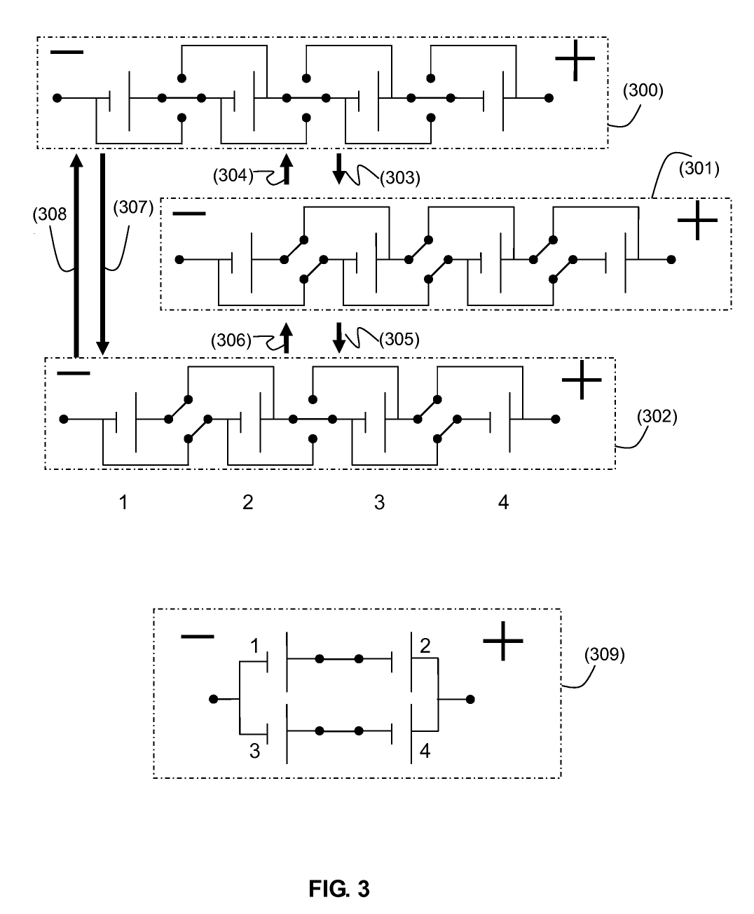

With reference to FIG. 3, four batteries are connected to different connective configurations by the combination of different state of series-parallel switches between batteries. For example, as shown in the drawing, the respective reference numeral 300 is 4S, 301 is 4P, 302 is 2P2S configuration of battery pack. The numeral 303, 304, 305, 306, 307, 308 show that one configuration can be change to another configuration by adjusting the corresponding states of series-parallel switches among batteries. The reference numeral 302 shows two batteries are connected in parallel (2P) first then two pairs of parallel-wound batteries are connected in series to form a battery pack (2P2S). The reference numeral 309 shows a conventional connection of four batteries, where two batteries are connected in series first and then the two pairs of series-wound batteries are connected in parallel to form a battery pack which is not the connective method of the present invention.

The activation of the series-parallel switch 201 is accomplished when the battery pack 101 is in the idle state. To further understand the operation of the series-parallel switches, a description of the states of battery pack 101 is provided.

Charging State:

Before entering the charging state, the series-parallel switches are activated by monitor processing unit 102 to connect the batteries to be 4S as shown in 300 of FIG. 3, 2P2S as shown in 302 of FIG. 3, or 4P as shown in 301 of FIG. 3, such that battery pack 101 is able to be charged by power conversion unit 103. During charging state, the monitor processing unit 102 can turn off the charging/discharging route, temporarily suspend the charging process, then change the states of series-parallel switches to be 4P 301, 2P2S 302, or 4S 300, then turn on the charging/discharging route to resume charging of the battery pack 101.

Discharging State:

Before entering the discharging state the monitor process unit 102 changes the states of series-parallel switches among batteries to be 4S 300, 2P2S 302, or 4P 301 so that the output voltage and current regulated by the power conversion unit 103 meet the design voltage and current of the load.

Not in Discharging State:

If the monitor processing unit 102 detects the difference in voltage or the state of charge among batteries is over a predetermined difference, then it records the connective states between batteries, the state of charging/discharging route and turn off the charging/discharging route. After that it changes the states of series-parallel switches of series-wound batteries to parallel-wound in a while to balance voltage, then restores the connective states of the battery pack 101 and the state of charging/discharging route.

The monitor processing unit 102 monitors each battery's status of a battery pack and detects if there is battery been protected and disabled by the circuit inside the battery, the monitor processing unit 102 can bypass such battery according as:

it is a series-wound only battery, changes the state of one adjacent series-parallel switch from series to parallel; or

it is a parallel-wound battery, a. changes the states of all the series-parallel switches to series-wound, then changes the state of one adjacent series-parallel switch from series to parallel; b. changes the states of rest series-parallel switches to proper parallel/serial connections; or c. changes the states of all series-parallel switches to parallel-wound.

Furthermore, the overall voltage of the battery pack 101 can be reduced by changing the connective configuration to be all parallel (e.g., 4P 301), or parallel/serial connection (e.g., 2P2S 302), such that assembly or disassembly of the battery pack be processed safely.

The description herein in merely exemplary in nature and, thus, variations such as using solar cell or fuel cell battery etc. that do not depart from the gist of that which is described are intended to be within the scope of the teachings. Such variations are not to be regarded as a departure from the spirit and scope of the teachings.

What is claimed is:

1. An apparatus for managing a plurality of batteries, comprising a battery pack is composed of a plurality of ordinal batteries, between each adjacent batteries is connected electrically by a series-parallel switch or by winding in series or parallel permanently, and at least exists one series-parallel switch can connect adjacent batteries in series or parallel.

2. The apparatus as claimed in claim 1, wherein the series-parallel switch is a double pole, double throw type mechanical switch, electronic MOS, or relay switch.

3. The apparatus as claimed in claim 2, wherein the type of battery pack is secondary rechargeable battery.

4. The apparatus as claimed in claim 2, wherein the type of battery pack is solar cell battery or fuel cell battery.

5. The apparatus as claimed in claim 3, further comprises a monitor processing unit can control the states of series-parallel switches among batteries and can control the on/off state of charging/discharging route of the battery.

6. The apparatus as claimed in claim 5, wherein the monitor processing unit can monitor the voltage and/or state of charge and/or protection status of batteries via the bus protocol or analog to digital converter.

7. A method for managing a plurality of batteries including a battery pack is composed of a plurality of ordinal batteries, between each adjacent batteries is connected by a series-parallel switch or by winding in series or parallel permanently, and at least exists one series-parallel switch, such switches can be controlled by manual or electronic controller, the method comprises changing the states of serial-parallel switches to be all parallel, all serial, or parallel/serial when the battery pack is not in charging/discharging.

8. The method as claimed in claim 7, wherein the type of battery pack is secondary rechargeable battery, solar cell battery or fuel cell battery.

9. The method as claimed in claim 8, further comprises reducing the overall voltage of the battery pack by changing the connections of batteries to be all parallel or parallel/serial connection before assembling or disassembling the battery pack.

10. The method as claimed in claim 8, further comprises bypassing a disabled battery according as:
it's series-wound only battery, changes the state of one adjacent series-parallel switch of this battery from series to parallel; or
it's parallel-wound battery, a. changes the states of all series-parallel switches to series-wound, then changes the state of one adjacent series-parallel switch of this battery from series to parallel; b. changes the states of rest series-parallel switches to be a proper parallel/serial connection; or c. changes the states of all series-parallel switches to parallel-wound.

11. The method as claimed in claim 8, further comprises balancing the voltages of series-wound batteries by changing the states of series-parallel switches among series-wound batteries to parallel-wound connection if the battery pack is secondary battery.

12. The method as claimed in claim 7, wherein the electronic controller can control the on/off state of charging/discharging route of the battery pack and can monitor the voltage and/or state of charge and/or protection status of batteries via the bus protocol or analog to digital converter.

13. The method as claimed in claim 12, further comprises detecting the difference in voltage or the state of charge of batteries is over a predetermined difference, if the battery pack is secondary battery, then it can record the connective states between batteries and the state of charging/discharging route, turns off the charging/discharging route, then changes switches of series-wound batteries to parallel-wound in a while to balance voltage, then restores the previous connective states of battery pack and restores the state of charging/discharging route when the battery pack is not in discharging.

14. The method as claimed in claim 12, further comprises turning off the charging/discharging route if the battery pack is secondary battery and in charging, temporarily suspend the charging process, then changes the states of series-parallel switches among batteries to be all parallel, all serial, or parallel/serial connection, and turn on the charging/discharging route to resume charging of the battery pack.
